(19) United States
(12) Patent Application Publication
(10) Pub. No.: US 2020/0218439 A1
(43) Pub. Date: Jul. 9, 2020

(54) SYSTEM AND METHOD FOR SEARCH RESULT VISUALISATION

(71) Applicant: Quark Inc., Santa Clara, CA (US)

(72) Inventors: Sanjeev Kumar, MILPITAS, CA (US); Prosenjit Sen, FREMONT, CA (US)

(21) Appl. No.: 16/733,421

(22) Filed: Jan. 3, 2020

Related U.S. Application Data
(60) Provisional application No. 62/788,506, filed on Jan. 4, 2019.

(51) Int. Cl. G06F 3/0485; G06F 16/248; G06F 16/25

(52) U.S. Cl. CPC G06F 3/04855; G06F 16/252; G06F 16/248

(57) ABSTRACT

A system for search result visualisation is disclosed. The system includes a display page configured to display the search result corresponding to a search request received from a user. The display page includes a designated display window including a display area configured to display a portion of a document from a source document, wherein the source document is corresponding to the search result. The designated display window also includes a graphical control element located adjacent to the display area in the designated display window, wherein the graphical control element is configured to control movement of the portion of the document in the display area to display a predefined preceding portion or a predefined succeeding portion of the source document.

This application claims priority from a provisional patent application filed in the US having Patent Application No. 62/788,506, filed on Jan. 4, 2019 and titled “SYSTEM AND METHOD FOR REDUCING TIME TAKEN TO FIND INFORMATION”.

### BACKGROUND

Embodiments of a present disclosure relates to information searching system, and more particularly to system and a method for search result visualisation.

Information search has evolved significantly since early days of development of Internet. A goal of the information search using search systems continues to be finding one or more most relevant documents for users to read. The users, for searching information, type keywords into a search box and send it to a search engine, wherein the search engine then returns links of one or more relevant documents that match with such keywords. Generally, the search engines upon searching, enable a search interface to display a snippet along with documents or document links, wherein the snippet includes one or more sentences in the document that have high keyword density. Various such systems are currently available which find the relevant information corresponding to the keywords provided by the user.

One such currently available system, includes determining the keyword density for the keywords provided by the user. However, the keyword density does not always correspond to the right answer. Also, one or more sentences with high keyword density does not necessarily indicate that the information sought by the user is in the given document. For example, the document could have used different wordings, paraphrasing, and grammatical constructs. So, the users typically end up trying various combinations of keywords and going through many documents before the users either find what they are looking for or the users decide to give up. Moreover, it is difficult to determine the keyword density for large size documents having complex formatting structures . . . . Furthermore, even if the high keyword density sentence in a document occurs at the right place in a document shown in search results, users still have to load that document and scroll or search through it to get to the right paragraph or section. So even in the best case (that is, when search found the relevant document), getting to the right information is time consuming.

Hence, there is a need for an improved system and a method for reducing time taken to find information in order to address the aforementioned issues.

### BRIEF DESCRIPTION

In accordance with an embodiment of the present disclosure, a system for search result visualisation is provided. The system includes a display page configured to display the search result corresponding to a search request received from a user. The display page includes a designated display window including a display area configured to display a portion of a document from a source document, wherein the source document is corresponding to the search result. The designated display window also includes a graphical control element located adjacent to the display area in the designated display window. The graphical control element is configured to control movement of the portion of the document in the display area to display a predefined preceding portion or a predefined succeeding portion of the source document.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a system for search result visualisation in accordance with an embodiment of the present disclosure;

FIG. 2 is a schematic representation of one embodiment of the system for search result visualisation in accordance in an embodiment of the present disclosure;

FIG. 3 is a schematic representation of another embodiment of the system for search result visualisation in accordance in an embodiment of the present disclosure;

FIG. 4 is a schematic representation of yet another embodiment of the system for search result visualisation in accordance with another embodiment of the present disclosure; and

FIG. 5 is a block diagram representation of an exemplary embodiment of the system for search result visualisation of FIG. 1 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for search result visualisation. The system includes a display page configured to display the search result corresponding to a search request received from a user. The display page includes a designated display window including a display area configured to display a portion of a document from a source document, wherein the source document is corresponding to the search result. The designated display window also includes a graphical control element located adjacent to the display area in the designated display window, wherein the graphical control element is configured to control movement of the portion of the document in the display area to display a predefined preceding portion or a predefined succeeding portion of the source document.

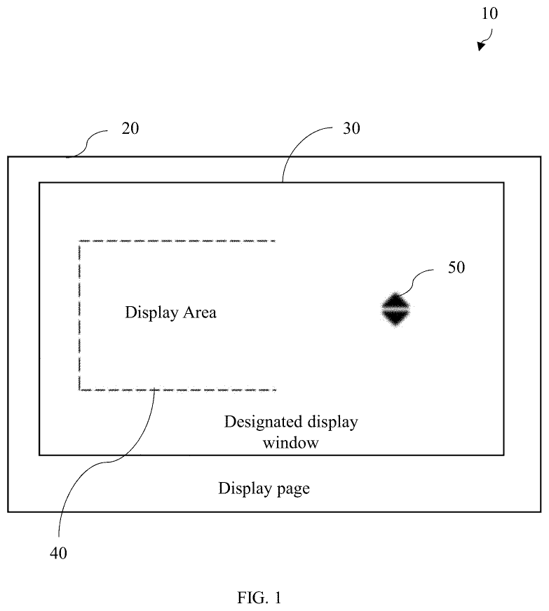

FIG. 1 is a block diagram representation of system 10 for search result visualisation in accordance with an embodiment of the present disclosure. The system 10 includes a display page 20 configured to display the search result corresponding to a search request received from a user. In one embodiment, the search request may include one or more questions or one or more keywords. In some embodiments, the system 10 includes a search request analysis subsystem which is configured to analyse an intent of the received search request by extracting one or more search terms from the received search request. In such embodiment, the search request analysis subsystem is further configured to fetch a source document corresponding to the received request from an internal repository based on an analysed intent. In one embodiment, the internal repository stores information from a plurality of sources. In such embodiment, the information may include webpages, PDF, power point, word documents, spreadsheets, images, videos and the like. In some embodiments, the plurality of sources may include document repository, internal ticketing system, customer facing ticketing systems, knowledge base articles, user and product manuals, internal and external webpages, customer relationship management systems and the like.

In one embodiment, the search request analysis subsystem may be configured to split the source document into a plurality of sub-documents by inserting one or more bookmarks in the source document based on a plurality of document splitting criteria. In such embodiment, the search request analysis subsystem may be configured to insert the one or more bookmarks in the source document stored in the internal repository. The search request analysis subsystem may inset the one or more bookmarks during pre-processing phase or ingestion phase. The bookmarks are inserted at either the beginning, middle and/or the end of paragraphs, images (for example, at beginning of image and/or near the image caption), at various rows of tabular data and/or at caption, at a plurality of places along the timeline of a video (for videos, the bookmarks may be stored externally as metadata), and the like.

In some embodiments, the information such as PDF, power point, word is converted into HTML and the bookmarks are inserted into the converted documents. The converted documents are then displayed in the display page when user clicks link in a search result. In another embodiment, if the source document format supports bookmarks (example, Microsoft Word) then the document is not converted to HTML. Instead, bookmarks are inserted directly into the source document format. In this embodiment, a capable graphical user interface (GUI) displays the source document in the full document display page and automatically scrolls to the location of the bookmark corresponding to the search result or associated link that is clicked by the user.

Furthermore, the display page 20 includes a designated display window 30 including a display area 40 configured to display a portion of a document from a source document, wherein the source document is corresponding to the search result. The portion of the document is displayed upon identifying a location of the portion of the document in the source document. In a specific embodiment, the portion of the document may be at least one of the paragraphs, a snippet, a sentence, a text, a phrase, a portion of a table, a portion of an image, a portion of a video or a combination thereof. In one embodiment, the display area 40 may be configured to display a highlighted version of the portion of the document. In such embodiment, the highlighting is achieved by a plurality of means including but not limited to showing the text in different colour, showing the text background in different colour, or showing the text in a different size, style, font or the like.

The display area 40 displays the exact portion of the document or media that answers the user's search request. For example, the display area 40 may display the exact paragraphs, exact portion of a table, exact image or exact video that answers the user's search request or the combination thereof. For example: If the display area 40 displays video either by itself or in combination with other information types then, the video is automatically fast-forwarded to the exact location on the timeline where the user's search request is answered or addressed. In a specific embodiment, the designated display window 30 is a window into the exact place in the document or information source and enables the user to scroll through the source.

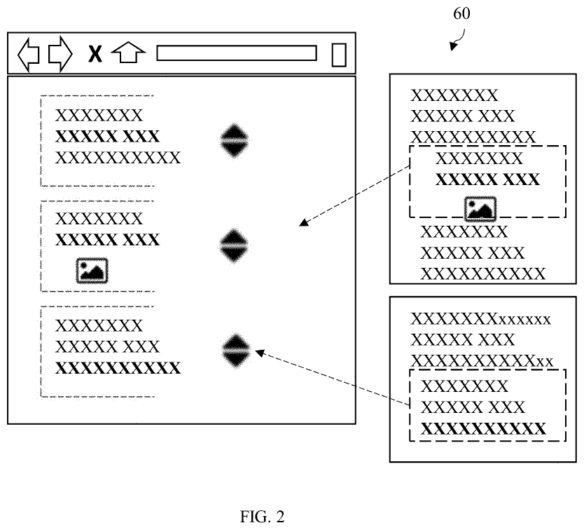

Moreover, the designated display window 30 includes a graphical control element 50 which is configured to control movement of the portion of the document in the display area 40. In one embodiment, the graphical control element 50 may include scrollbars, swiping up and down or sliders. In some embodiments, the graphical control element 50 enables the user to scroll a predefined preceding portion or a predefined succeeding portion of the source document based on inserted bookmark. For example, if the display area shows information from the source document such as webpage, PDF, word document, power point slide, or spreadsheet then the user may seamlessly scroll through that document starting from the answer paragraph. For example, the user may scroll to see paragraphs before the answer paragraph and seamlessly scroll to the top of the document. Similarly, the user may scroll to see paragraphs after the answer paragraph all the way to the bottom of the document as shown in FIG. 2. For example, in one implementation 60, the user may only see the previous and the next paragraph of the answer paragraph so that the user may see the context around the answer paragraph quickly without scrolling too far away from the relevant search result. Here, the answer paragraph is representative of the portion of the document.

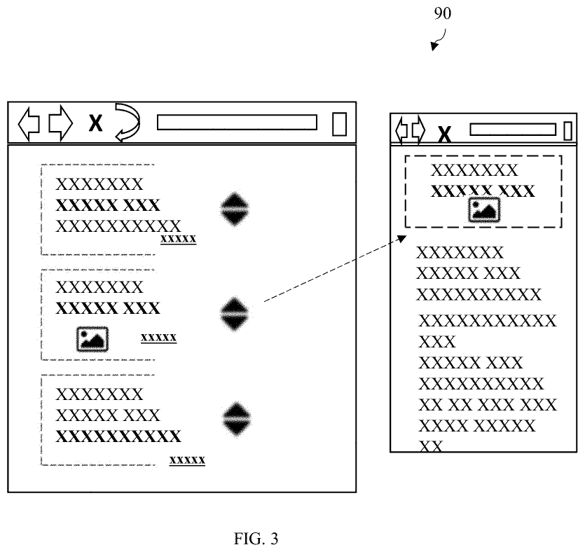

In one embodiment, the display area 40 may be configured to display complete version 90 of the source document when the user clicks on the portion of the document. For example, when the user clicks the link in a relevant search result then another designated display window that loads the source document for the corresponding relevant search result and automatically scrolls to the exact paragraph that is displayed in the relevant search results. The user may then scroll up and down the document as needed starting from the answer paragraph as shown in FIG. 3.

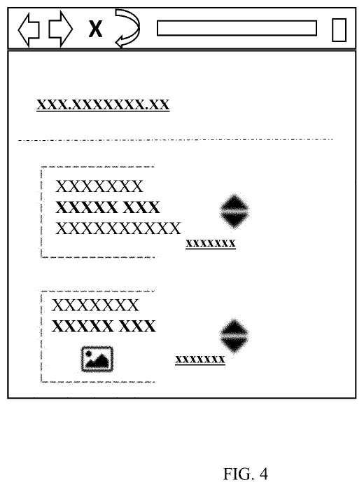

In some embodiments, the display page 20 may include a plurality of designated display windows 40 corresponding to the plurality of search results such that each display window 40 shows results from a different source document. In some embodiments, the designated display window 40 may include a plurality of display areas and corresponding plurality of graphical control element, wherein each of the plurality display areas are configured to display corresponding plurality of search results from a document corresponding to multiple possible answers from different portions of the same document as shown in FIG. 4. For example, if the user requested to search for, “how many languages are spoken in India?” then in a document, one passage on page #7 may display “there are 22 official languages in India” and another passage on page #36 may display “there are more than 19500 languages spoken across India” and both are correct answers. Hence, in this case, the display area displays two paragraphs for that document, each paragraph with its own link.

In a specific embodiment, the multiple documents corresponding to the search results may be displayed in a single window such that it enables the user to examine the answer contexts of multiple documents simultaneously. For example, scrolling to see previous or succeeding paragraph for one search result also displays the corresponding previous and succeeding paragraphs of more than one search result on the results page. In another embodiment, the user may provide the one or more keywords for searching instead of asking a question. In such embodiment, the display area 40 may show search results in a similar fashion as the answers. In yet another embodiment, the display area may display suggested possible questions that the user might be interested in asking based on the keywords entered by the user. When the user clicks any suggested question then the search result visualisation subsystem displays a relevant search result from the plurality of sources. In such embodiment, the suggestions may be generated based on but not limited to appending the question phrases (example: “what is”, “how do I”) and optionally correcting the question so formed grammatically and searching historical questions that contain main keywords entered by the user. In some embodiment, the suggested questions may be displayed as links clickable by the user. In another embodiment, the clickable link is displayed using other user interface techniques such as dropdown lists.

In some embodiments, the graphical control element 50 enables the user to scroll from a passage in the search result to that passage in the source document where automatic scrolling from the search result to the relevant passage in the source document is via user action. The user has to choose to go an answer passage in the source document by clicking on a result in the display area 40 or an associated link for that passage. In another embodiment, the graphical control element 50 enables the user to scroll from a passage in the search result to that passage in the source document where the relevant passage is automatically displayed in the display area of the graphical user interface (GUI) window for the associated viewer for the source document. In yet another embodiment, the graphical control element 50 enables the user to scroll from a passage in the search result to that passage in the source document where the associated viewer for the source document (for example, web browser for html documents, PDF viewer for PDF documents, MS Word for Word documents.) renders into the display window a portion of the source document containing the relevant passage.

In a specific embodiment, the graphical control element 50 may be configured to control movement of the portion of the document in the display area to display the portion of the document located based on one or more bookmarks and their corresponding one or more locations in the internal repository, wherein the one or more bookmarks and their corresponding locations are generated beforehand (at the time of ingesting the source document). In another embodiment, the graphical control element 50 may scroll to the relevant passages in a document where each bookmark is associated with a small portion of the source document (for example, one or more paragraphs, sections, table rows, parts of lists, sentences) by splitting the source document into a plurality of subdocuments. In yet another embodiment, the graphical control element 50 may scroll to the relevant passages in a document where a version of source document is generated with bookmarks inserted at their respective locations and these modified documents are shown to user when user requests to scroll to the location of answer paragraph in source document. In such embodiment, the one or more bookmarks may be inserted at the time of ingestion or in the source document at a location of the portion of the document when the user requests to scroll to the source document. In yet another embodiment, the graphical control element 50 may scroll to the relevant passages in a document where the link associated with each search result includes a reference to the bookmark corresponding to that passage in the source document.

In an alternative embodiment, the graphical control element 50 may scroll to the relevant passages in a document where the location of the relevant passage (for example, xpath in case of HTML files) is sent to designated display window or to the associated viewer of the source document. The source document or copy is then modified to insert a bookmark so that viewers (such as web browsers) automatically scroll to the right passage in the source document upon clicking a search result that includes a reference to the location of the passage.

In one embodiment, the display area 40 may be configured to display one or more additional information corresponding to the search result. The additional information is controlled based on a graphical control element. In one embodiment, the display area 40 may be configured to display a colour coded confidence score corresponding to the portion of the document. The confidence score is representative of a degree of relevancy of the search result. Based on the confidence score, the user may decide whether to extract further information related to the relevant search result. In a specific embodiment, the documents (obtained via external search) along with all reference information is removed from the system after some time and not added to the repository permanently. These are available for answering questions only for a specified time after ingestion.

In one embodiment, the system 10 answers questions from real-time email and chat (such as Slack feeds). The user asks a question and optionally specifies the real-time feed to the user. In one embodiment, the system 10 monitors incoming feed and sends them to question answering models. If answers are found, then they are displayed to the user either via user interface or via offline channels such as email. In one embodiment, the feed content (example, anew email or anew chat) is sent to question answering models only if they match a shortlisting criterion.

In a specific embodiment, the user may specify one or more search engines along with the one or more questions, the one or more keywords and the number of results to the system 10. In such embodiment, the system 10 may perform search by using the selected search engine's API (application programming interface) or by web scraping or the like. The specified number of documents may then be fetched and ingested. Further, the display area may display the answers to the user's question from the ingested documents. In another embodiment, the user may ask questions again after the system 10 confirms that the results from specified selected search engines have been ingested.

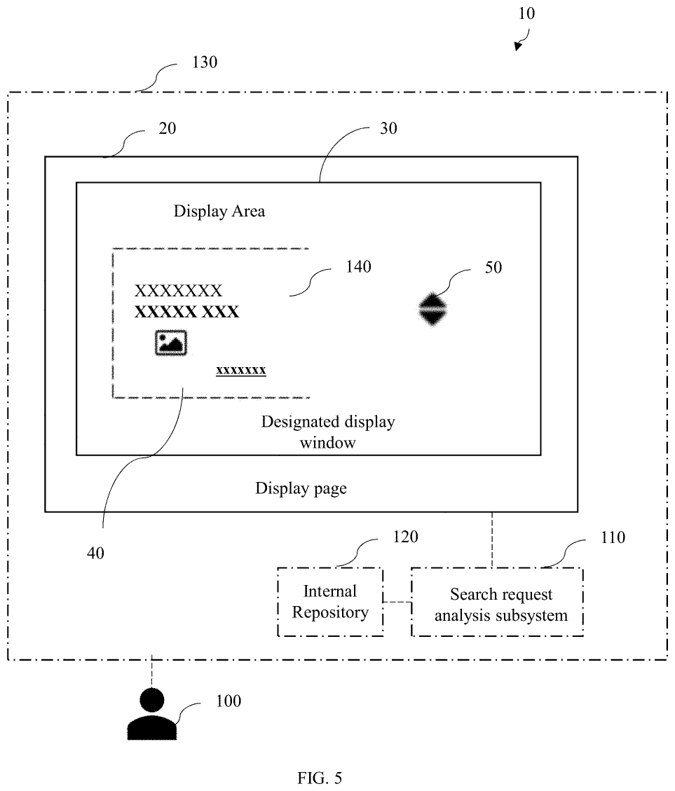

FIG. 5 is a block diagram representation of an exemplary embodiment of the system 10 for search result visualisation of FIG. 1, in accordance with an embodiment of the present disclosure. Considering an example where a user 100 asks a question “what is artificial intelligence?” to the system. The search request analysis subsystem 110 of the system 10 receives the search request (question) and analyse the search request by extracting one or more search terms from the questions and identify the intent from the question. Further, the search result analysis subsystem 110 determines a location of the answer corresponding to the asked question in information stored in the internal repository. In one embodiment, the search result analysis subsystem 110 inserts bookmark in the source document at the answer location. In another embodiment, the information stored in the internal repository 120 may include a plurality of documents collected from a plurality of sources. In such embodiment, the search result analysis subsystem 110 inserts corresponding plurality of bookmarks in the plurality of documents at the plurality of answer locations. In another embodiment, bookmarks are inserted during pre-processing or ingestion phase of documents into the internal repository 120. In such embodiment, the search result analysis subsystem 110 identifies the existing bookmarks that correspond to the locations of answers.

Furthermore, based on the question, the search result analysis subsystem 110 identifies a source document (for example a word document) which includes the answer of the question asked by the user 100. The system also includes a display page 20 which may be visualised in an electronic device 130 associated with the user 100. In such embodiment, the electronic device 130 may include, but not limited to, a mobile phone, a personal computer, a laptop, a tablet or the like. The display page 20 includes designated display window 30 including a display area 40 which displays an answer of the question asked by the user 100. The display area 40 displays the exact portion 140 of the document that answers the user's question. In the current example, the display area 40 displays the exact portion 140 of the paragraph present in the source document which answer the question “what is artificial intelligence?”. In one embodiment, the display area 40 may display the answer sentences in highlighted form to distinguish the answer sentences from the succeeding and preceding sentences and paragraphs.

Moreover, the designated display window 30 includes a graphical control element 50 (for example a scroll bar) which enables the user 100 to scroll through that document starting from the answer paragraph. For example, the user wants to see the further explanation after the definition of artificial intelligence or the categories of artificial intelligence, then the system 10 enables the user to scroll the document after the highlighted answer paragraph 140 to see the further portions of the word document. In a case when user 100 clicks on the highlighted answer paragraph in the display area or clicks the link associated with the highlighted answer paragraph then, another designated display window such as a browser tab opens that loads a webpage (such as Wikipedia™) which displays the detailed information from where the source document for that search result is prepared. Further, the system automatically scrolls to the exact paragraph that is displayed in the search results. The user 100 may then scroll up and down the document as needed starting from the answer paragraph.

In another case where user has provided few keywords instead of a particular question to the system 10 then the display area displays a list of questions as suggestion to the user. For example, the user X has provided the keywords like “artificial” “intelligence” or “AI”, then the display area displays the questions corresponding to the keywords as suggestion such as “what is artificial intelligence?”, “what are the types of artificial intelligence?”, what are the various categories of the artificial intelligence?” or the like. In one embodiment, the suggested questions are displayed as links clickable by the user; in another embodiment, they are displayed using other user interface techniques such as dropdown lists.

Various embodiments of the system for search result visualisation described above enables the user to quickly find information. The system introduces a paradigm shift for search by enabling users to find information that they are looking for without spending time in guessing keywords and without having to read through documents linked in search results. The designated display window may not load the full document but a large portion of it (for example, multiple paragraphs or table rows) so that the user may see the full context of the answer paragraph without having to scroll and search through the entire document.

Furthermore, the system takes advantage of current web standards and built-in capability of compatible browsers to navigate to a bookmark in an HTML document when bookmark is specified as part of the document URL.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for search result visualisation comprising:
a display page configured to display the search result corresponding to a search request received from a user, wherein the display page comprises:
a designated display window comprising:
a display area configured to display a portion of a document from a source document, wherein the source document is corresponding to the search result; and
a graphical control element located adjacent to the display area in the designated display window, wherein the graphical control element is configured to control movement of the portion of the document in the display area to display a predefined preceding portion or a predefined succeeding portion of the source document.

2. The system of claim 1, wherein the search request comprises one or more questions or one or more keywords.

3. The system of claim 1, wherein the portion of the document comprises at least one of paragraphs, a snippet, a sentence, a text, a phrase, a portion of a table, a portion of an image, a portion of a video or a combination thereof.

4. The system of claim 1, wherein the display area is configured to display a colour coded confidence score corresponding to the portion of the document, wherein the confidence score is representative of a degree of relevancy of the at least one relevant search result.

5. The system of claim 1, wherein the display area is configured to display a list of questions suggested to the user based on one or more keywords provided by the user.

6. The system of claim 1, wherein the source document is stored in an internal repository.

7. The system of claim 1, wherein the designated display window comprises a plurality of display areas and a corresponding plurality of graphical control element, wherein each of the plurality of display areas is configured to display a corresponding plurality of search results.

8. The system of claim 1, wherein the graphical control element comprises scrollbars, swiping up and down or sliders.

9. The system of claim 1, wherein the display area is configured to display complete version of the source document when the user clicks on the portion of the document.

10. The system of claim 1, wherein the graphical control element is configured to enable the user to scroll to the search result in the source document by clicking on the search result in the display area or a link associated with the search result.

11. The system of claim 1, wherein the display area of the designated display window is configured to display the portion of the document for an associated viewer of the source document.

12. The system of claim 11, wherein the associated viewer for the source document renders into the designated display window comprising the portion of the source document.

13. The system of claim 1, wherein the graphical control element is configured to control movement of the portion of the document in the display area to display the portion of the document located based on one or more bookmarks and corresponding one or more locations in the internal repository.

14. The system of claim 13, wherein each of the one or more bookmarks is associated with a portion of the source document by splitting the source document into a plurality of subdocuments.

15. The system of claim 14, wherein the one or more bookmarks are inserted at the time of ingestion or in the source document at a location of the portion of the document when the user requests to scroll to the source document.

16. The system of claim 1, wherein the graphical control element is configured to control movement of the portion of the document in the display area to display the portion of the document based on a location of the portion of the document sent to designated display window or to the associated viewer of the source document.
